(19) United States
(12) Patent Application Publication
(10) Pub. No.: US 2023/0103727 A1
(43) Pub. Date: Apr. 6, 2023

(54) View Holes For Heavy Quick Union Collars

(71) Applicant: Hunting Energy Services Ltd., Aberdeen (GB)

(72) Inventors: Alexander James Wilkie, Newtonhill (GB); Daniel O'brien, Stonehaven (GB)

(73) Assignee: Hunting Energy Services Ltd., Aberdeen (GB)

(21) Appl. No.: 17/906,100

(22) PCT Filed: Mar. 12, 2021
(86) PCT No.: PCT/IB2021/000145

§ 371 Date: Sep. 12, 2022

Related U.S. Application Data
(60) Provisional application No. 62/988,782, filed on Mar. 12, 2020.

(30) Foreign Application Priority Data
Mar. 12, 2021 (IB) PCT/IB2021/000145

(51) Int. Cl. F16L 19/02; F16L 19/025

(52) U.S. Cl. CPC F16L 19/0231; F16L 19/025; F16L 2201/10

(57) ABSTRACT

A collar assembly that couples the pin end of a first pipe with the box end of a second pipe and provides for a visual inspection of the alignment.

### RELATED APPLICATIONS

This application claims priority to U.S. Provisional Application No. 62/988,782, filed Mar. 12, 2020.

### BACKGROUND OF THE INVENTION

Pipeline or equipment installation (temporary or otherwise) operations in the oilfield require the coupling of multiple pipes, valves or other equipment in rapid succession and the connections (known as quick unions) must be properly threaded in order to gain the desired strength from each connection. Currently, a heavy collar must be lifted clear of the connection to check alignment of critical features (which poses a manual handling and safety risk due to potentially trapped fingers), or the connection may be made up without checking alignment, which poses a potential risk of equipment failure, release of high pressure and associated dangers, hydrocarbon release to the environment, and/or dropped objects. As a result, there is a need to improve the way pipe is aligned quickly and effectively.

### BRIEF SUMMARY OF THE INVENTION

An example embodiment may include a union collar comprising a hollow cylindrical housing having a first end, a second end, an inner threaded portion (the collar) adapted to couple to the outer threads of a union box and further adapted to seat a union pin against a union box, and at least one window cutout proximate to the second end, wherein the window allows for visual confirmation of the alignment of the inner threads the outer threads of a union box.

A variation of the example embodiment may include at least one window cutout being a plurality of window cutouts located about the hollow cylindrical housing. It may include the at least one window cutout being an elongated slotted cutout that breaks through the end face of the collar. It may include at least one window cutout being a circular thru hole or other shape that does not break through the end face of the collar.

An example embodiment may include a union collar assembly comprising a first hollow cylindrical housing have a first end, a second end, a shoulder portion adapted to guide and hold a union pin of a first pipe against a union box of a second pipe, a second hollow cylindrical housing having a first end, a second end, an inner threaded portion adapted to couple to the outer threads of the union box of a second pipe and seat the union pin of the first pipe against a union box, and at least one window cutout proximate to the second end, wherein the window allows for visual confirmation of the alignment of the inner threads the outer threads of a union box.

An example embodiment may include a method for coupling pipe comprising aligning a first pipe with a pin end with a union collar, locating the pin end inside the union collar, resting the pin end on a box end of a second pipe, visually checking that the threads are aligned via a cutout in the union collar, and threading the first pipe into the second pipe.

A variation of the example embodiment may include the cutout in the union collar is at least one window cutout. The union collar may have a plurality of window cutouts located about a hollow cylindrical housing. The cutout may be an elongated slotted cutout. The cutout may be a circular thru hole.

### BRIEF DESCRIPTION OF THE SEVERAL VIEWS OF THE DRAWING

FIG. 1A shows an quick union pin, collar assembly, and quick union box prior to connection

FIG. 1B shows cross section view of an quick union pin, collar assembly, and quick union box prior to connection.

FIG. 1C shows an assembly of the quick union pin, collar assembly, and quick union box.

FIG. 1D shows a cross section view of the assembly of the quick union pin, collar assembly, and quick union box.

FIG. 2A shows an assembly of the quick union pin, collar assembly, and quick union box with the pin engaged in the box, prior to engaging the collar; it is important the two parts are mated as shown, and the collar viewing window allows this to be confirmed and without lifting the collar to prevent obstruction of the view.

FIG. 2B shows a cross section of the assembly of the quick union pin, collar assembly, and quick union box.

FIG. 2C shows a closed up of the mating view hole for verifying the assembly of the quick union pin, collar assembly, and quick union box.

FIG. 3A shows an assembly of the quick union pin, collar assembly, and quick union box fully assembled with the collar fully assembled

FIG. 3B shows a cross section of the assembly of the quick union pin, collar assembly, and quick union box.

### DETAILED DESCRIPTION OF THE INVENTION

In the following description, certain terms have been used for brevity, clarity, and examples. No unnecessary limitations are to be implied therefrom and such terms are used for descriptive purposes only and are intended to be broadly construed. The different apparatus, systems and method steps described herein may be used alone or in combination with other apparatus, systems and method steps. It is to be expected that various equivalents, alternatives, and modifications are possible within the scope of the appended claims.

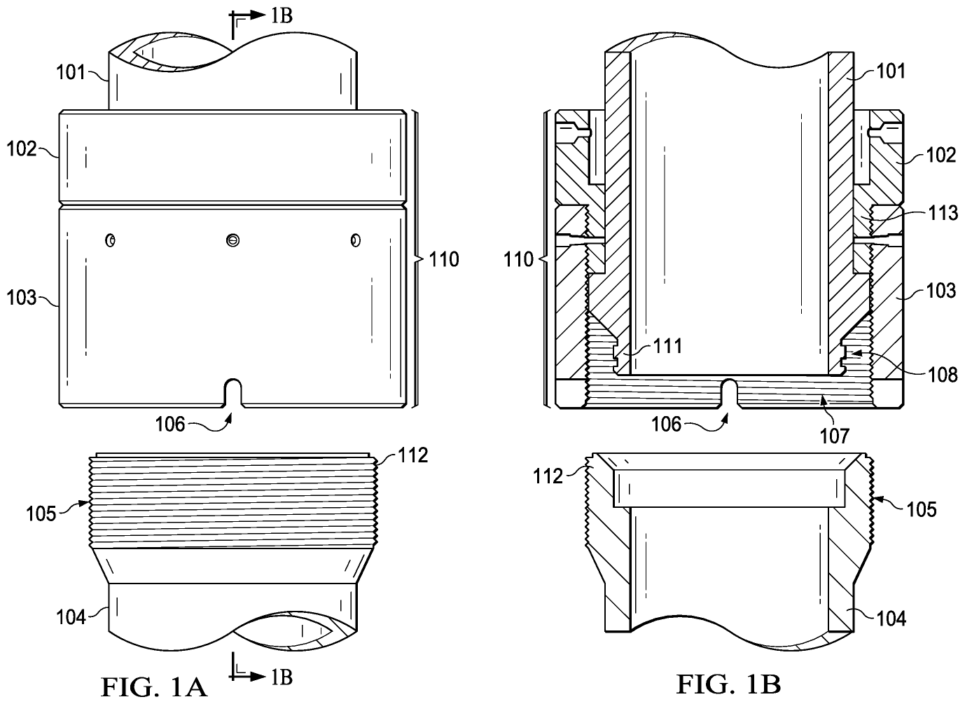

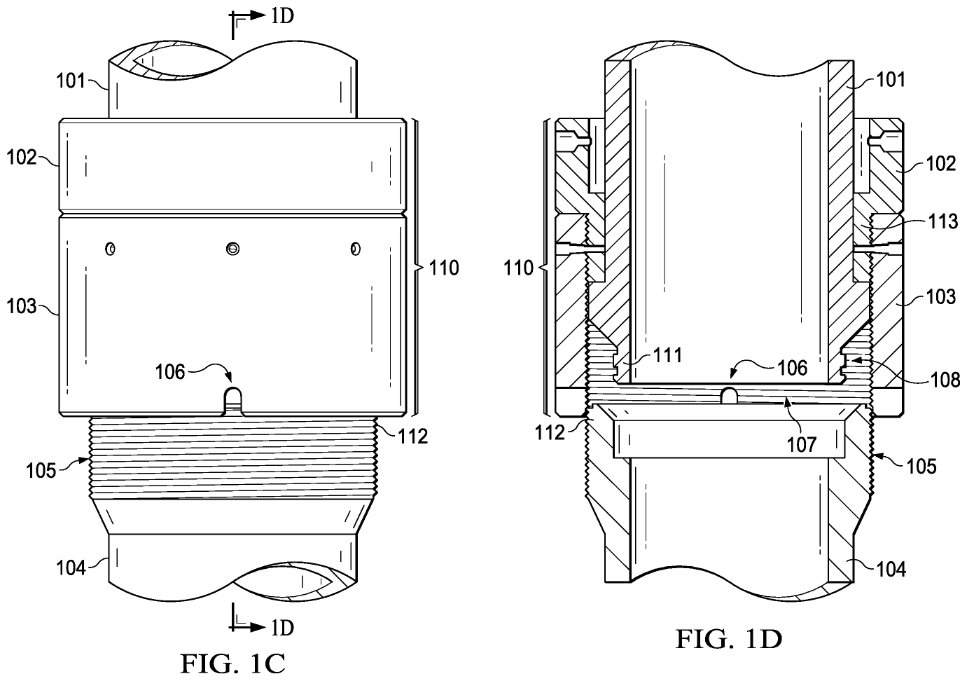

An example embodiment of the union assembly is shown in FIG. 1A. An quick union pin 111 of a first pipe 101 is coupled to the upper collar 102 and lower collar 103 to form a collar assembly 110. The lower collar 103 includes a window cutout 106. The collar assembly 110, couples the quick union pin 111 with the quick union box end 112 of a second pipe 104. The quick union box end 112 has outer threads 105.

In FIG. 1B the quick union pin 111 of a first pipe 101 is coupled to the upper collar 102 and lower collar 103 to form a collar assembly 110. The lower collar 103 includes a window cutout 106. The collar assembly 110, couples the quick union pin 111 with the quick union box end 112 of a second pipe 104. The quick union box end 112 has outer threads 105. Lower collar 103 includes inner threads 107. The first pipe 101 has a pin end 108. The upper collar 102 includes shoulder 113 for holding the quick union pin 111 of the first pipe 101 against, and engaged with, the quick union box end 112 of the second pipe 102.

In FIG. 1C the quick union pin 111 of a first pipe 101 is coupled to the upper collar 102 and lower collar 103 to form a collar assembly 110. The lower collar 103 includes a window cutout 106. The collar assembly 110, couples the quick union pin 111 with the quick union box end 112 of a second pipe 104. The quick union box end 112 has outer threads 105. The initial mating of the lower collar 103 with the outer threads 105 of the quick union box end 112 is aligned using the window cutout 106.

In FIG. 1D the quick union pin 111 of a first pipe 101 is coupled to the upper collar 102 and lower collar 103 to form a collar assembly 110. The lower collar 103 includes a window cutout 106. The collar assembly 110, couples the quick union pin 111 with the quick union box end 112 of a second pipe 104. The quick union box end 112 has outer threads 105. The initial mating of the lower collar 103 with the outer threads 105 of the quick union box end 112 is aligned using the window cutout 106. The pin end 108 of the first pipe 101 has not seated in the second pipe 104. Furthermore, the lower collar 103 is resting on the first thread of the outer threads 105 of the quick union box end 112.

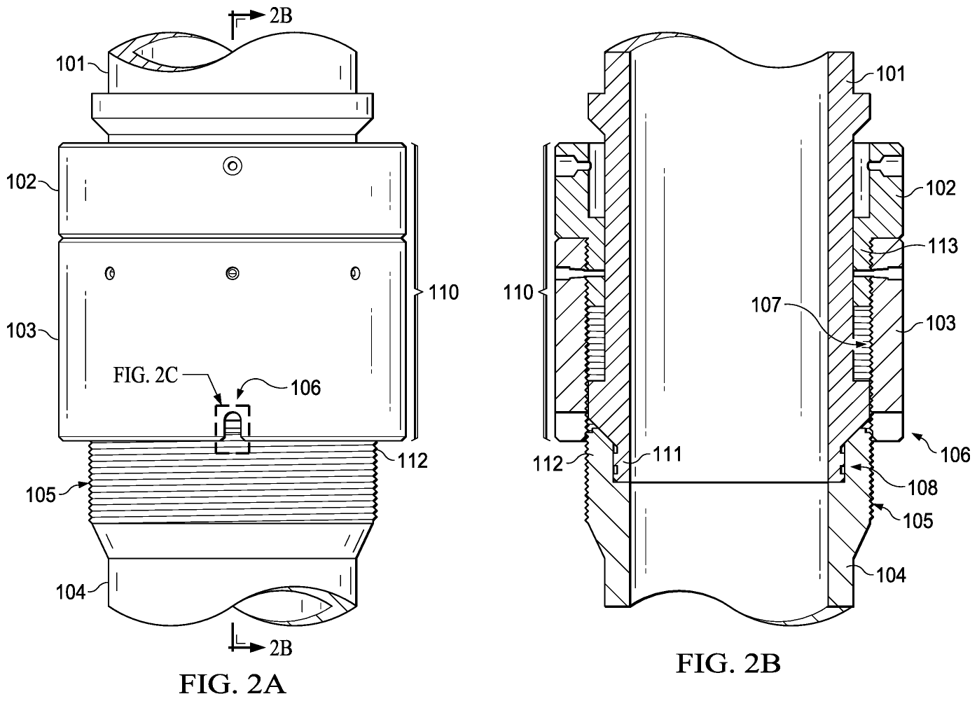

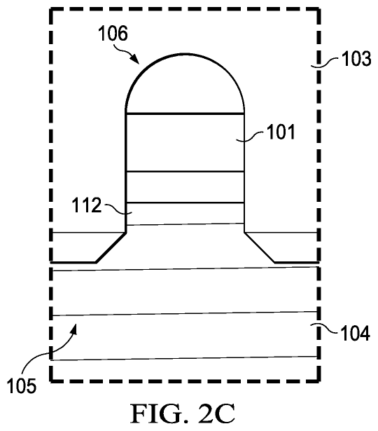

In FIG. 2A, 2B, and 2C the quick union pin 111 of a first pipe 101 is coupled to the upper collar 102 and lower collar 103 to form a collar assembly 110. The lower collar 103 includes a window cutout 106. The collar assembly 110, couples the quick union pin 111 with the quick union box end 112 of a second pipe 104. The quick union box end 112 has outer threads 105. The pin end 108 of the first pipe 101 is seated in the second pipe 104, the alignment of the quick union box end 112 is observed using the window cutout 106. The upper collar 102 includes shoulder 113 for holding the quick union pin 111 of the first pipe 101 against, and engaged with, the quick union box end 112 of the second pipe 102.

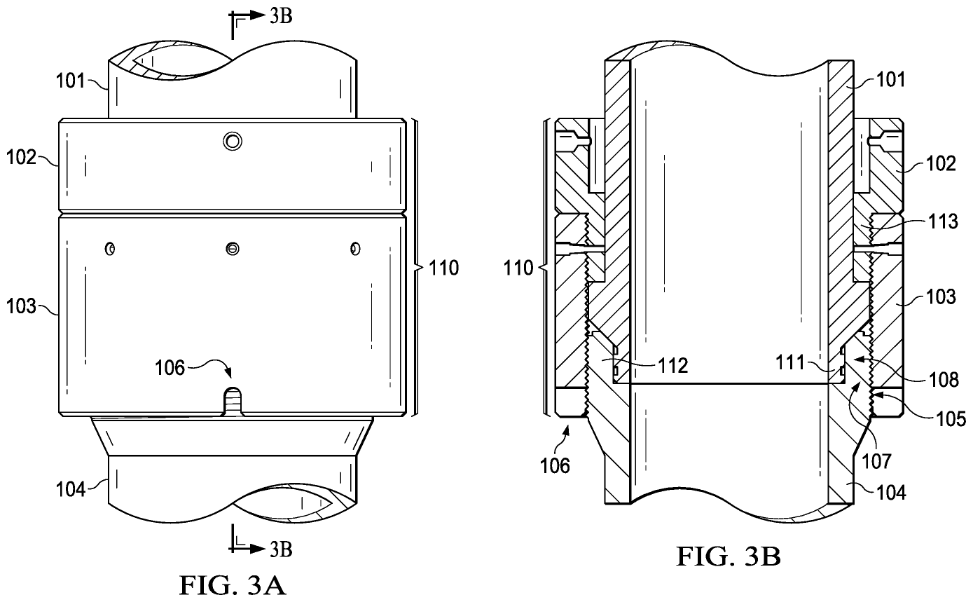

In FIG. 3A and 3B the quick union pin 111 of a first pipe 101 is coupled to the upper collar 102 and lower collar 103 to form a collar assembly 110. The lower collar 103 includes a window cutout 106. The collar assembly 110, couples the quick union pin 111 with the quick union box end 112 of a second pipe 104. The quick union box end 112 has outer threads 105. The pin end 108 of the first pipe 101 is seated in the second pipe 104, the alignment of the quick union box end 112 is observed using the window cutout 106. The lower collar 103 is tightened to secure the connection and fully couple the first pipe 101 with the second pipe 104, while providing for the correct alignment via window cutout 106. The upper collar 102 includes shoulder 113 for holding the quick union pin 111 of the first pipe 101 against, and engaged with, the quick union box end 112 of the second pipe 102.

In the examples provided, a single window cutout 106 is depicted, but a pluarlity of window cutouts could be used around the lower collar 104. The window cutout 106 may be a hole or an elongated slot. The elongated slot provides flexibility in that it is easier to align the view window with the shoulder with the viewer's perspective. A window cutout 106 that is a hole could be round, square, or any other shape, preferably shaped to reduce stress concentrations. The elongated slot version of the window cutout 106 as depicted may include rounded corners or square corners.

In the examples provided, the lower collar 103 is depicted as an integral cylindrical housing, but it could be formed by welding or joining two cylindrical pieces to form an extended collar and then machined. In another example, the lower collar 103 could be formed from semi-circular housing pieces welded to the bottom and spaced apart to make the single window cutout 106 portions. This process requires no machining, only welding, and can be added to existing collars.

Although the invention has been described in terms of embodiments which are set forth in detail, it should be understood that this is by illustration only and that the invention is not necessarily limited thereto. For example, terms such as upper and lower or top and bottom can be substituted with uphole and downhole, respectfully. Top and bottom could be left and right, respectively. Uphole and downhole could be shown in figures as left and right, respectively, or top and bottom, respectively. Pipe can be any piece of equipment with a through bore that can be joined to another piece of equipment. The first housing and second housing may be top housing and bottom housing, respectfully. Terms like connection, union, quick union, connector, and other alternatives may be used synonymously. Terms like pipe, accessory, pressure control equipment, or PCE, and other alternatives may be used synonymously. The alternative embodiments and operating techniques will become apparent to those of ordinary skill in the art in view of the present disclosure. Accordingly, modifications of the invention are contemplated which may be made without departing from the spirit of the claimed invention.

What is claimed:

1. A union collar comprising:
a hollow cylindrical housing having a first end, a second end, an inner threaded portion adapted to couple to the outer threads of a union box and seat a union pin against a union box; and
at least one window cutout proximate to the second end, wherein the window allows for visual confirmation of the alignment of the inner threads the outer threads of a union box.

2. The union collar of claim 1 wherein the at least one window cutout is a plurality of window cutouts located about the hollow cylindrical housing.

3. The union collar of claim 1 wherein the at least one window cutout is an elongated slotted cutout.

4. The union collar of claim 1 wherein the at least one window cutout is a circular thru hole.

5. A union collar assembly comprising:
a first hollow cylindrical housing has a first end, a second end and shoulder portion adapted to guide and hold a union pin of a first pipe against a union box of a second pipe;
a second hollow cylindrical housing having a first end, a second end, an inner threaded portion adapted to couple to the outer threads of the union box of a second pipe and seat the union pin of the first pipe against a union box; and
at least one window cutout proximate to the second end, wherein the window allows for visual confirmation of the alignment of the inner threads the outer threads of a union box.

6. The union collar of claim 5 wherein the at least one window cutout is a plurality of window cutouts located about the hollow cylindrical housing.

7. The union collar of claim 5 wherein the at least one window cutout is an elongated slotted cutout.

8. The union collar of claim 5 wherein the at least one window cutout is a circular thru hole.

9. A method for coupling pipe comprising:
aligning a first pipe with a pin end with a union collar;
locating the pin end inside the union collar;
resting the pin end on a box end of a second pipe;
visually checking that the threads are aligned via a cutout in the union collar; and
threading the first pipe into the second pipe.

10. The method of claim 9 wherein the cutout in the union collar is at least one window cutout.

11. The method of claim 9 wherein the cutout in the union collar is a plurality of window cutouts located about the hollow cylindrical housing.

12. The method of claim 9 wherein the cutout is an elongated slotted cutout.

13. The method of claim 9 wherein the cutout is a circular thru hole.
